(19) United States
(12) Patent Application Publication
(10) Pub. No.: US 2011/0016500 A1
(43) Pub. Date: Jan. 20, 2011

(54) METHOD FOR BROADCASTING CUSTOMISED INFORMATION ON AN IPTV NETWORK AND DEVICE FOR IMPLEMENTING SAID METHOD

(76) Inventor: Bahman Mobasser, Maurepas (FR)

Correspondence Address: FAY SHARPE/LUCENT, 1228 Euclid Avenue, 5th Floor, The Halle Building, Cleveland, OH, 44115-1843, US

(21) Appl. No.: 12/808,802

(22) PCT Filed: Dec. 17, 2008
(86) PCT No.: PCT/FR08/52327

§ 371 Date: Sep. 16, 2010

(30) Foreign Application Priority Data
Dec. 17, 2007 (FR) 0708791

(51) Int. Cl. H04N 7/173

(52) U.S. Cl. 725/109

(57) ABSTRACT

A method for broadcasting personalized information, for a determined type of information, within a television-over-IP network, which method comprises:
the saving of the users' preferences from at least one terminal of the television-over-IP network, for the determined type of information;
the creation of personalized information data, intended for at leas that terminal of the television-over-IP network;
the verification that the duration over which the personalized information data created is broadcast is roughly equal to the duration over which the non-personalized information data is broadcast;
the insertion, within the stream of data broadcast over a multipoint network connection (multicast), of personalized information data, broadcast in peer-to-peer mode (unicast).

The invention relates to the technical field of television-over-IP, known as IPTV.

The implementation of television-over-IP makes it possible to enhance conventional television content with services available over a network besides the television broadcast network. This additional network may, for example, be the network of an Internet service provider. The services correspond, for example, to providing resources which may be additional pages of program guides, trailers, or text data about a film being shown.

The document Matthias et. al. “A reference architecture supporting hypervideo content for ITV and the internet domain” Computers & Graphics 28, 2004 pp. 179-191 describes the implementation of hypervideo applications for IPTV.

The Applicant has developed two interactive television-over-IP applications: AmigoTV and MyOwnTV.

The interactive television technology denominated AmigoTV enables the user to share opinions and feelings within a community. When several friends watch the same TV program, with AmigoTV they can comment on it live among themselves, with their voices travelling over the Internet; in this way, six people can communicate at the same time. To know who has the TV switched on, and what channel they are watching, users simply consult, by means of a remote control, a menu where all such information is displayed in real time, with the presence of the members of the community being indicated by superimposed avatars. AmigoTV also enables sending images and sounds chosen from a catalogue, to illustrate one's mood in reaction to an event broadcast over TV.

MyOwnTV is another user-focused triple play offer, enabling users to share multimedia content (photographs, videos) within a restricted circle, with an integrated videophony service intended to enable, in the future, dialogues within the virtual community. The multimedia contents are seen by the members of the community by means of a television/decoder set. With this solution, there is no real time interaction and the mobile environment is not taken into account. The protection o he data is ensured by authentication.

The development of television-over-IP requires a proper understanding of users' expectations. Several studies have been conducted to that effect (see, for example, Shin “Potential user factors driving adoption of IPTV. What are customers expecting from OPTV”, Technological Forecasting & Social Change 74, 2007, pp. 1446-1464).

The personalization of the content broadcast by IPTV appears to be one of the important factors to take into account. This personalization has undergone developments regarding the broadcasting of advertising messages. For example, one may refer to the Applicant's European patent application EP 1826981.

Patent application WO 2007/120332, also filed in the Applicant's name, describes a device and method for broadcasting personalized advertising messages, the personalization being based on geomarketing information. The personalization may also be carried out depending on the viewing context. For example, advertising messages about food products will be broadcast to television sets found in home kitchens, and advertisements for new animated cartoons will be broadcast to sets found in childrens' rooms (micro-level context awareness).

The invention intends to disclose a method and device enabling a personalization of television-over-IP programs, this personalization being implemented in a user-friendly manner.

To these ends, the invention pertains, according to a first aspect, to a method for broadcasting personalized information, for a determined type of information, within a television-over-IP network, which method comprises:

the saving of the users' preferences from at least one terminal of the television-over-IP network, for the determined type of information;

the creation of personalized information data, intended for at least that terminal of the television-over-IP network;

the verification that the duration over which the personalized information data created is broadcast is roughly equal to the duration over which the non-personalized information data is broadcast;

the insertion, within the stream of data broadcast over a multipoint network connection (multicast), of personalized information data, broadcast in peer-to-peer mode (unicast).

Advantageously, for the determined type of information, the personalized information data is created while ensuring that the duration of their broadcast is roughly equal to the duration of the broadcast of the non-personalized information data. The users therefore do not perceive any interruption in the stream of data. The personalization is discreet.

Advantageously, the saving of users' preferences is performed after selecting a profile of preferences from among a set of predetermined profiles.

Advantageously, the saving of users' preferences is performed after selecting or defining a profile on the website of a service provider. This profile selection or definition may be performed with the assistance of a fixed or mobile communication terminal.

The invention, according to a second aspect, pertains to a device for broadcasting personalized information, for a determined type of information, within a television-over-IP network, which device comprises:

means for saving the users' preferences from at least one terminal of the television-over-IP network, for the determined type of information;

means for creating personalized information data, intended for at least that terminal of the television-over-IP network;

means for inserting, within the stream of data broadcast over a multipoint network connection (multicast), personalized information data, broadcast in peer-to-peer mode (unicast).

Advantageously, the device comprises means for selecting a profile of preferences from among a set of predetermined profiles.

Advantageously, the device comprises means for selecting or defining a profile on the website of a service provider.

Other objects and advantages of the invention will become apparent by reading the description below of currently preferred embodiments.

In the remainder of this description, the personalized information is of a simple determined type: weather forecasts.

However, it is understood that the type of information may be different from weather forecasts.

The examples below illustrate the great variety of possible applications for the inventive method and device.

In a first series of possible applications, some users wish to replace an information stream, of a first given type, broadcast in multicast mode, with an information stream of another type. For example, the broadcasting of violent films may be replaced with the broadcasting of general-audience films, enabling parental control. The broadcasting of an already-watched program may be replaced with the broadcasting of another program, In particular, the users of IPTV terminals will be able to decide whether to watch, in unicast mode, a film by a given director, instead of another film by that director, broadcast in multicast mode.

In a second series of possible applications, some users wish to adjust the information stream to their areas of interest.

These areas of interest may lead users to replace one sequence of programs with another one. For example, sports results will be replaced with stock quotes.

These areas of interest may lead users to prefer one camera angle to another, for a given piece of information. For example, for an international event, the user may decide to receive reporting from German television, instead of reporting from Belgian television. During the rebroadcast of a sporting event, the user will be able to receive only images shot on the field (such as inside a racecar) rather than the rebroadcast intended for everyone.

These areas of interest may be related to the context in which a fixed or mobile IPTV terminal's user is present. For example, when the user has returned home, information about traffic jams might no longer be of interest to him or her, this information being replaced, for example, with the next day's weather forecasts.

The information benefits from a relative standardization of durations of information sequences (music videos, films. TV films, news segments), facilitating the construction of personalized programs.

Thus, for example, a discreet substitution, in the case of weather forecasts, is possible when the duration of the national information sequence is roughly identical to the regional or local information sequences.

For a determined type of information (for example, weather forecasts), the users of at least one IPTV terminal first save their preferences.

Depending on these preferences, the broadcaster will create personalized information data intended for at least that terminal of the television-over-IP network.

This personalized data will then be inserted and broadcast in peer-to-peer method (unicast), within the stream of data broadcast over a multipoint network connection (multicast).

Advantageously, for the determined type of information, the personalized information data is created while ensuring that the duration of their broadcast is roughly equal to the duration of the broadcast of the non-personalized information data. The users therefore do not perceive any interruption in the stream of data. The personalization is discreet.

In one embodiment, the saving of the users' preferences is done after selecting a profile of preferences from among a set of predetermined profiles.

In one particular embodiment, the saving of the users' preferences is done after selecting or defining a profile on the website of a service provider. This profile selection or definition may be performed with the assistance of a fixed or mobile communication terminal.

1. A method for broadcasting personalized information, for a determined type of information, within a television-over-IP network, which method comprises:
the saving of the users' preferences from at least one terminal of the television-over-IP network, for the determined type of information;
the creation of personalized information data, intended for at least that terminal of the television-over-IP network;
the verification that the duration over which the personalized information data created is broadcast is roughly equal to the duration over which the non-personalized information data is broadcast;
the insertion, within the stream of data broadcast over a multipoint network connection (multicast), of personalized information data, broadcast in peer-to-peer mode (unicast).

2. A method according to claim 1, characterized in that the saving of the users preferences is done after selecting a profile of preferences from among a set of predetermined profiles.

3. A method according to claim 1, characterized in that the saving of the users' preferences is done after selecting or defining a profile on the website of a service provider.

4. A device for broadcasting personalized information, for a determined type of information, within a television-over-IP network, which device comprises:
means for saving the users preferences from at least one terminal of he television-over-IP network, for the determined type of information;
means for creating personalized information data, intended for at leas hat terminal of the television-over-IP network;
means for verifying that the duration over which the personalized information data created is broadcast is roughly equal to the duration over which the non-personalized information data is broadcast;
means for inserting, within the stream of data broadcast over a multipoint network connection (multicast), personalized information data, broadcast in peer-to-peer mode (unicast).

5. A device according to claim 4, characterized in that it comprises means for selecting a profile of preferences from among a set of predetermined profiles.

6. A device according to claim 4, characterized in that it comprises means for selecting or defining a profile on the website of a service provider.
